(19) United States
(12) Patent Application Publication
(10) Pub. No.: US 2008/0297567 A1
(43) Pub. Date: Dec. 4, 2008

(54) INK-JET PRINT HEAD AND METHOD OF MANUFACTURING THE SAME

(75) Inventors: Jae-Sik Min, Suwon-si (KR); O hyun Beak, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/034,048

(22) Filed: Feb. 20, 2008

(30) Foreign Application Priority Data
May 29, 2007 (KR) 2007-52075

(51) Int. Cl. B41J 2/05; G01D 15/00

(52) U.S. Cl. 347/64; 216/27

(57) ABSTRACT

An ink-jet print head and a method of manufacturing the same capable of minimizing exfoliation or breakage of a protective layer. The ink-jet print head includes a heater layer which is provided on a substrate, a wire layer which is provided on the heater layer and is formed to expose a predetermined region of the heater layer, a protective layer which covers predetermined regions of the wire layer and the heater layer, and an over coat layer which covers evenly uneven portions on the protective layer.

### CROSS-REFERENCE TO RELATED APPLICATIONS

This application claims the benefit of Korean Patent Application No. 2007-0052075, filed on May 29, 2007 in the Korean Intellectual Property Office, the disclosure of which is incorporated herein by reference in its entirety.

### BACKGROUND OF THE INVENTION

1. Field of the Invention

The present general inventive concept relates to an ink-jet print head and a method of manufacturing the same, and more particularly to an ink-jet print head and a method of manufacturing the same that is capable of preventing exfoliation or damage of a protective layer which protects a wire layer.

2. Description of the Related Art

An ink-jet print head is a device which forms an image by ejecting ink droplets on a printing medium. One type of the ink-jet print head is configured to generate bubbles by heating an ink using a heater and eject ink droplets in a chamber through a nozzle by an expansive power of the bubbles.

An example of a conventional ink-jet print head is disclosed in U.S. Pat. No. 6,293,654. This conventional ink-jet print head includes an insulation layer, a heater layer, a wire layer, a protective layer and a cavitation prevention layer, which are placed in sequence on a substrate, such as a silicon wafer. The heater layer heats an ink filled in an ink chamber, and the wire layer forms a wiring pattern to apply electric power to the heater layer. The insulation layer insulates the heater layer and the substrate from each other, so that the heat generated from the heater layer is transferred to the ink in the ink chamber. The protective layer insulates the heater layer and the wire layer from the ink to protect the heater layer and the wire layer, and the cavitation prevention layer prevents the heater layer from being broken due to cavitation force which is generated when the ink bubbles in the ink chamber contract after the ink ejection.

Typically, when manufacturing the print head, the heater layer is formed by depositing a heat resistant material, such as tantalum-aluminum (Ta—Al) alloy, on an upper surface of the insulation layer, and the wire layer is formed by depositing a conductive metal material, such as aluminum (Al), on an upper surface of the heater layer. The wire layer permits a portion of the upper surface of the heater layer to be exposed through a photolithography process or an etching process, and forms a wiring pattern or a circuit pattern to apply electric power to the heater layer. The protective layer is formed by depositing silicon nitride (SiNx) on the heater layer and the wire layer, and the cavitation prevention layer is formed by depositing tantalum (Ta) on the protective layer and performing a photolithography process or a dry etching process.

However, the conventional ink-jet print head as manufactured above has the problem that the protective layer may be broken in the manufacturing process due to a step of the wiring pattern on the wire layer. Specifically, recently, in order to increase a degree of integration of the wires, the wire layer is thickened to about 8000 Å and the wires are narrowed in consideration of a wire resistance. Thus, a stress is concentrated on the protective layer, near an edge of the wire layer, by which the protective layer is easily broken. This is also because there is a limitation in an increase in the thickness of the protective layer with respect to the heat transfer of the heater layer. Also if the cavitation prevention layer (Ta layer) having a large compressive stress is formed on the protective layer, the residual stress increases, and thus the wire layer and the protective layer may get loose or may be exfoliated.

### SUMMARY OF THE INVENTION

The present general inventive concept provides an ink-jet print head and a method for manufacturing the same that is capable of minimizing exfoliation or breakage of a protective layer.

Additional aspects and/or advantages of the invention will be set forth in part in the description which follows and, in part, will be obvious from the description, or may be learned by practice of the invention.

The foregoing and/or other aspects and utilities of the present general inventive concept can be achieved by providing an ink-jet print head including a heater layer which is provided on a substrate; a wire layer which is provided on the heater layer and is formed to expose a predetermined region of the heater layer; a protective layer which covers predetermined regions of the wire layer and the heater layer; and an over coat layer which covers evenly uneven portions on the protective layer.

The over coat layer is partially eliminated on a region above a heat generating area of the heater layer.

The ink-jet print head further includes a cavitation prevention layer which is formed on the protective layer.

The over coat layer is made of a material selected from a group consisting of photosensitive oxide, photosensitive polymide, photosensitive polyamide, and photosensitive epoxy.

The over coat layer is made of phosphosilicate glass (PSG).

The foregoing and/or other aspects and utilities of the present general inventive concept can also be achieved by providing a method of manufacturing an ink-jet print head, including forming a heater layer which is provided on a substrate; forming a wire layer which is provided on the heater layer and is formed to expose a predetermined region of the heater layer; forming a protective layer which covers predetermined regions of the wire layer and the heater layer; forming an over coat layer which covers evenly uneven portions on the protective layer; and forming a chamber layer which is provided on the over coat layer and defines an ink chamber.

The method can further include forming an insulation layer on the substrate before forming the heater layer.

The forming the wire layer can include forming a metal layer by depositing a conductive metal material on an upper surface of the heater layer by vacuum vapor deposition, eliminating a portion of the metal layer, which is located on a region above a heat generating area of the heater layer, by wet etching, and eliminating selectively the metal layer by dry etching to form a wiring pattern.

The protective layer can be formed by depositing silicon nitride (SiNx) by plasma enhanced chemical vapor deposition (PECVD).

The forming the over coat layer can include coating evenly a material selected from the group consisting of photosensitive oxide, photosensitive polymide, photosensitive polyamide, and photosensitive epoxy, on the protective layer, and eliminating a portion of the over coat layer, which is located on a region above a heat generating area of the heater layer, by photolithography or etching.

Alternatively, the forming the over coat layer can include coating evenly phosphosilicate glass (PSG) on the protective layer, and eliminating a portion of the over coat layer, which is located on a region above a heat generating area of the heater layer, by etching.

The foregoing and/or other aspects and utilities of the present general inventive concept can also be achieved by providing an ink-jet print head including a heater layer provided on a substrate; a wire layer provided on the heater layer and formed to expose a predetermined region of the heater layer at an ink chamber region; and a protective layer which covers the wire layer and the heater layer and has a planer upper surface.

The protective layer can be provided to have the planer upper surface by applying a coating layer thereon.

The foregoing and/or other aspects and utilities of the present general inventive concept can also be achieved by providing a method of manufacturing an ink-jet print head, including: forming a heater layer on a substrate; forming a wire layer above the heater layer and to expose a predetermined region of the heater layer at an ink chamber region; forming a protective layer to cover the wire layer and the heater layer such that the protective layer has a planer upper surface; and forming a chamber layer on the planer surface of the protective layer to define the ink chamber region.

The protective layer can be formed with a planer upper surface by applying a first layer on the wire layer to cover the wire layer and by applying a second layer over the first layer to provide the planer upper surface.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a sectional view illustrating a schematic constitution of an ink-jet print head in accordance with an embodiment of the present general inventive concept; and

FIGS. 2 to 8 are views illustrating a method of manufacturing the ink-jet print head in accordance with embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

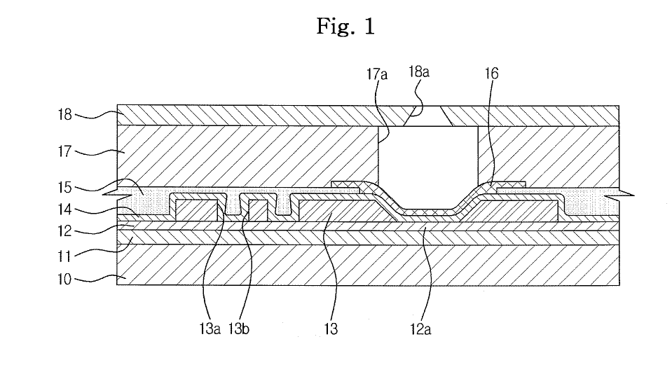

FIG. 1 is a sectional view of an ink-jet print head in accordance with an embodiment of the present general inventive concept. As illustrated in FIG. 1, an ink-jet print head includes a substrate 10 which is made of silicon, a chamber layer 17 which is placed on the substrate 10 and defines an ink chamber 17a, and a nozzle layer 18 which is placed on the chamber layer 17. The ink-jet print head further includes a heater layer 12 which is provided between the chamber layer 17 and the substrate 10 to heat an ink in the ink chamber 17a, an insulation layer 11 which is provided between the heater layer 12 and the substrate 10 for heat and electric insulation, a wire layer 13 which is provided on the heater layer 12, a protective layer 14 which covers an upper surface of the wire layer 13, an over coat layer 15 which is provided on the protective layer 14, and a cavitation prevention layer 16 which is provided on a region below the ink chamber 17a.

The heater layer 12 is formed by depositing a heat resistant material, such as tantalum nitride (TaN) or tantalum-aluminum alloy, on an upper surface of the insulation layer 11. When electric power is applied to the heater layer 12, a heat generating area 12a underlying the ink chamber 17a heats the ink in the ink chamber 17a. By heating the ink, bubbles are generated in the ink located in the ink chamber 17a, and the ink is ejected from the ink chamber 17a through a nozzle 18a of the nozzle layer 18 by the expansion of the bubbles.

The wire layer 13 forms a wiring pattern to apply electric power to the heat generating area 12a of the heater layer 12. The wire layer 13 is formed by the deposition of a conductive metal material, such as aluminum (Al), and the wiring pattern is formed by a photolithography process or an etching process of the deposited metal layer. A portion of the wire layer 13, which corresponds to a region below the ink chamber 17a, is eliminated so that the heat generating area 12a of the heater layer 12 can heat the ink. The wire layer 13 may form a wiring pattern which supplies electric power to the heat generating area 12a of the heater layer 12 or may form a print head operating circuit pattern. In this embodiment, the wire layer 13 is formed to have a thickness of about 8000 Å. This is to minimize a wire resistance by securing sufficiently a cross-sectional area of the wires while increasing a degree of integration by decreasing a width of the wires.

The protective layer 14 protects the heater layer 12 and the wire layer 13 by preventing the heater layer 12 and the wire layer 13 from being oxidized and being directly contacted by the ink. The protective layer 14 is made of silicon nitride (SiNx) deposited on the heater layer 12 and the wire layer 13 by a thickness of about 3000 Å. To form the protective layer 14 to be thin is so that the ink in the ink chamber 17a can be sufficiently heated by the heat generation area 12a of the heater layer 12.

The over coat layer 15 coats an upper surface of the protective layer 14 with planarity, which is previously uneven due to the uneven structure of the wire layer 13. The over coat layer 15 protects the protective layer 14 by covering valley portions or other stepped portions with a predetermined thickness, which are formed by the wiring pattern of the wire layer 13. Especially, the over coat layer 15 protects the thin portions of the protective layer 14 on an edge 13a or a valley portion 13b of the wire layer 13, thereby preventing the breakage of the protective layer 14. This is to securely protect the wire layer 13 and the heater layer 12 by preventing the breakage of the protective layer 14 in the print head manufacturing process or thereafter.

The over coat layer 15 is not formed on a region above the heat generating area 12a of the heater layer 12, i.e., a region below the ink chamber 17a. More particularly, the over coat layer 15 is originally formed overall on the heater layer 12, and then a portion of the over coat layer 15 located on the region above the heat generating area 12a is eliminated by a photolithography process or an etching process. Preferably, the over coat layer 15 is made of a photosensitive material, such as photosensitive oxide, photosensitive polymide, photosensitive polyamide, photosensitive epoxy, etc. Besides, the over coat layer 15 may be made of a non-photosensitive material, such as phosphosilicate glass (PSG).

The cavitation prevention layer 16 protects the heater layer 12 from a cavitation force which is generated when the bubbles in the ink chamber 17a contract and vanish, and prevents the heater layer 12 from corroding due to the ink. The cavitation prevention layer 16 is formed by depositing tantalum (Ta) on the protective layer 14 by a predetermined thickness.

The chamber layer 17 is provided on the over coat layer 15 and the cavitation prevention layer 16 by using epoxy. The ink chamber 17a defined by the chamber layer 17 is connected with an ink supply path (not shown), so that the ink is supplied continuously into the ink chamber 17a. The nozzle layer 18 covers an upper surface of the chamber layer 17, and has the nozzle 18a to eject the ink. The nozzle 18a is positioned above the heat generating area 12a of the heater layer 12 so as to smoothly eject the ink when the bubbles are generated in the ink chamber 17a by being heated by the heater layer 12.

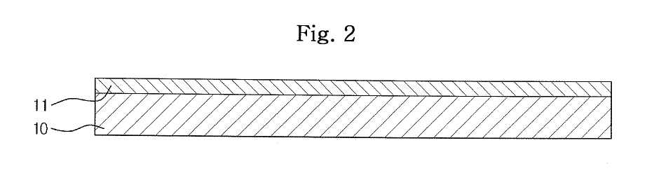

Hereinafter, a method of manufacturing the ink-jet print head according to an embodiment of the present general inventive concept will be described with reference to FIGS. 2 to 8.

FIG. 2 illustrates a state in which the insulation layer 11 is formed on the substrate 10. The substrate 10 is configured as a silicon wafer which is commonly used in manufacturing a semiconductor device and is adequate for mass production. The insulation layer 11 is formed by depositing silicon dioxide (SiO2) on the upper surface of the substrate 10 by a predetermined thickness. The insulation layer 11 has a function of heat insulation by preventing a thermal energy from the heater layer 12 from being transferred to the substrate 10, as well as a function of electric insulation between the substrate 10 and the heater layer 12.

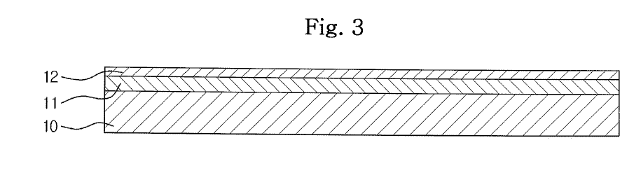

FIG. 3 illustrates a state in which the heater layer 12 is formed on the insulation layer 11. The heater layer 12 is formed by depositing a heat resistant material, such as tantalum nitride (TaN), tantalum-aluminum (TaAl) alloy, titanium nitride (TiN), tungsten silicide, etc., on the upper surface of the insulation layer 11 by a thickness of about 1000 Å.

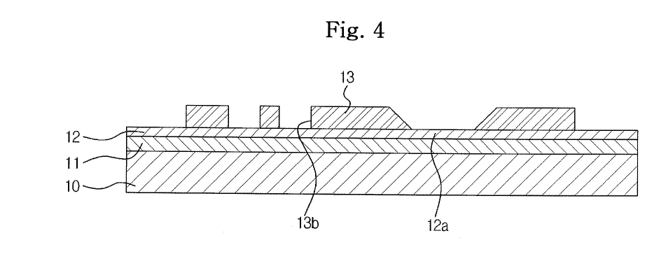

FIG. 4 illustrates a state in which the wire layer 13 is formed on the heater layer 12. When forming the wire layer 13, a metal having a good conductivity, such as aluminum (Al), is first deposited on the upper surface of the heater layer 12 by vacuum vapor deposition to make a metal layer having a thickness of about 8000 Å. A portion of the metal layer, which is located on the region above the heat generating area 12a of the heater layer 12, is eliminated by a wet etching process. This is to expose the upper surface of the heat generating area 12a of the heater layer 12 so that the heat generating area 12a of the heater layer 12 can heat the ink in the ink chamber 17a. The remaining portion of the metal layer, which is spaced apart from the heat generating area 12a, is partially eliminated by a dry etching process to form the valley portion 13b. Accordingly, the wire layer 13 forms the wiring pattern.

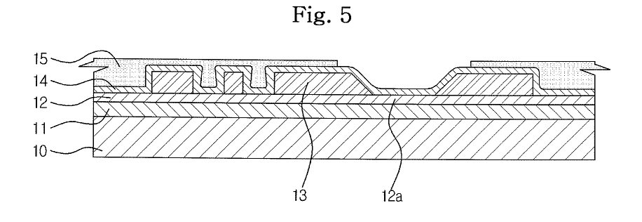

FIG. 5 illustrates a state in which the protective layer 14 and the over coat layer 15 are formed on the wire layer 13. The protective layer 14 is formed by depositing silicon nitride (SiNx) on the heater layer 12 and the wire layer 13 by plasma enhanced chemical vapor deposition (PECVD) by a thickness of about 3000 Å. The protective layer 14 protects the heater layer 12 and the wire layer 13 from the oxidization or the contact with the ink.

As illustrates in FIG. 5, the over coat layer 15 is formed on the upper surface of the protective layer 14 after the protective layer 14 is formed. When forming the over coat layer 15, any one material selected from photosensitive oxide, photosensitive polymide, photosensitive polyamide, and photosensitive epoxy is first coated evenly on the protective layer. After coating the above material evenly on the whole protective layer 14, a portion of the over coat layer, which is located on a region above the heat generating area 12a of the heater layer 12, is eliminated by a photolithography process or an etching process. By this, as illustrated in FIG. 5, the over coat layer 15 covers the upper surface of the protective layer 14 except for the region above the heat generating area 12a of the heater layer 12. Such an over coat layer 15 covers evenly all the uneven portions, i.e., the valley portions or other stepped portions, which are formed by the wiring pattern of the wire layer 13, thereby protecting the protective layer 14.

The over coat layer 15 may be made of a non-photosensitive material, such as phosphosilicate glass (PSG). In this case, a portion of the over coat layer 15, which is located on the region above the heat generating area 12a of the heater layer 12, is eliminated by an etching process.

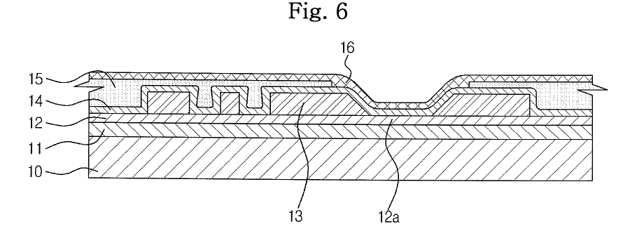

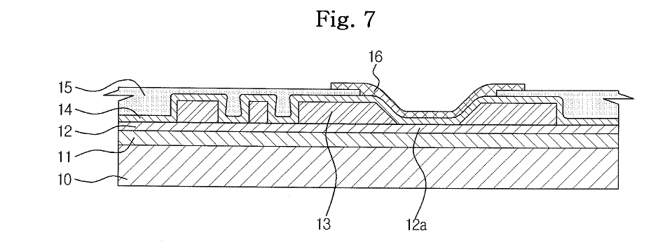

FIGS. 6 and 7 illustrate a state in which the cavitation prevention layer 16 is formed on the over coat layer. When forming the cavitation prevention layer 16, as illustrated in FIG. 6, tantalum (Ta) is first deposited on the upper surfaces of the protective layer 14 (region above the heat generating area of the heater layer) and the over coat layer 15. Then, as illustrated in FIG. 7, the cavitation prevention layer 16 is patterned such that only a portion of the cavitation prevention layer 16 located on the region above the heat generating area 12a of the heater layer 12 remains by a photolithography process or an etching process. When eliminating tantalum (Ta) located on the over coat layer 15 in the patterning of the cavitation prevention layer 16, because the over coat layer 15 protects the protective layer 14, the breakage of the protective layer 14 can be prevented.

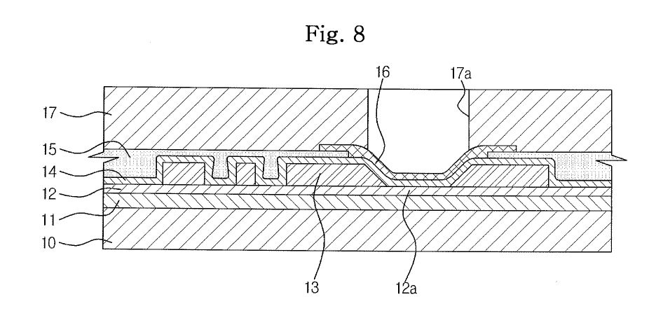

FIG. 8 illustrates a state in which the chamber layer 17 defining the ink chamber 17a is formed on the cavitation prevention layer 16 and the over coat layer 15. After the chamber layer 17 is formed as illustrated in FIG. 8, the nozzle layer 18 is lastly formed on the chamber layer 17 as shown in FIG. 1.

As apparent from the above description, the ink-jet print head according to an embodiment of the present general inventive concept has an effect of stably protecting the protective layer by preventing the breakage of the protective layer because the over coat layer formed on the protective layer covers evenly all the uneven portions which are formed by the wiring pattern of the wire layer.

Further, since the over coat layer covers the upper surface of the protective layer, the following processes, after the over coat layer is formed, can be easily performed. Still further, during performing such processes, since the over coat layer securely protects the protective layer, the breakage of the protective layer can be prevented.

Although few embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An ink-jet print head comprising:
a heater layer provided on a substrate;
a wire layer provided on the heater layer and formed to expose a predetermined region of the heater layer;
a protective layer which covers predetermined regions of the wire layer and the heater layer; and
an over coat layer which covers evenly uneven portions on the protective layer.

2. The ink-jet print head according to claim 1, wherein the over coat layer is partially eliminated on a region above a heat generating area of the heater layer.

3. The ink-jet print head according to claim 1, further comprising:
a cavitation prevention layer formed on the protective layer.

4. The ink-jet print head according to claim 1, wherein the over coat layer is made of a material selected from the group consisting of photosensitive oxide, photosensitive polymide, photosensitive polyamide, and photosensitive epoxy.

5. The ink-jet print head according to claim 2, wherein the over coat layer is made of a material selected from the group consisting of photosensitive oxide, photosensitive polymide, photosensitive polyamide, and photosensitive epoxy.

6. The ink-jet print head according to claim 3, wherein the over coat layer is made of a material selected from the group consisting of photosensitive oxide, photosensitive polymide, photosensitive polyamide, and photosensitive epoxy

7. The ink-jet print head according to claim 1, wherein the over coat layer is made of phosphosilicate glass (PSG).

8. A method of manufacturing an ink-jet print head, comprising:
forming a heater layer which is provided on a substrate;
forming a wire layer on the heater layer and to expose a predetermined region of the heater layer;
forming a protective layer which covers predetermined regions of the wire layer and the heater layer;
forming an over coat layer which covers evenly uneven portions on the protective layer; and
forming a chamber layer provided on the over coat layer and defines an ink chamber.

9. The method according to claim 8, further comprising:
forming an insulation layer on the substrate before forming the heater layer.

10. The method according to claim 8, wherein the forming the wire layer includes:
forming a metal layer by depositing a conductive metal material on an upper surface of the heater layer by vacuum vapor deposition;
eliminating a portion of the metal layer, which is located on a region above a heat generating area of the heater layer, by wet etching; and
eliminating selectively the metal layer by dry etching to form a wiring pattern.

11. The method according to claim 8, wherein the protective layer is formed by depositing silicon nitride (SiNx) by plasma enhanced chemical vapor deposition (PECVD).

12. The method according to claim 8, wherein the forming the over coat layer includes:
coating evenly a material selected from the group consisting of photosensitive oxide, photosensitive polymide, photosensitive polyamide, and photosensitive epoxy, on the protective layer; and
eliminating a portion of the over coat layer, which is located on a region above a heat generating area of the heater layer, by photolithography or etching.

13. The method according to claim 8, wherein the forming the over coat layer includes:
coating evenly phosphosilicate glass (PSG) on the protective layer; and
eliminating a portion of the over coat layer, which is located on a region above a heat generating area of the heater layer, by etching.

14. An ink-jet print head comprising:
a heater layer provided on a substrate;
a wire layer provided on the heater layer and formed to expose a predetermined region of the heater layer at an ink chamber region; and
a protective layer which covers the wire layer and the heater layer and has a planer upper surface.

15. The ink-jet print head according to claim 14, wherein the protective layer is provided with a planer upper surface by applying a coating layer thereon.

16. A method of manufacturing an ink-jet print head, comprising:
forming a heater layer on a substrate;
forming a wire layer above the heater layer and to expose a predetermined region of the heater layer at an ink chamber region;
forming a protective layer to cover the wire layer and the heater layer such that the protective layer has a planer upper surface; and
forming a chamber layer on the planer surface of the protective layer to define the ink chamber region.

17. The method according to claim 16, wherein the protective layer is formed with a planer upper surface by applying a first layer on the wire layer to cover the wire layer and by applying a second layer over the first layer to provide the planer upper surface.
